(19) United States
(12) Patent Application Publication
(10) Pub. No.: US 2013/0257607 A1
(43) Pub. Date: Oct. 3, 2013

(54) WARNING DEVICE AND COLLISION AVOIDANCE SYSTEM

(71) Applicant: FLOW-RITE SAFETY SOLUTIONS INC., BURLINGTON (CA)

(72) Inventors: Malcolm Paul RIGBY, BURLINGTON (CA); Gerard Michael DOWNS, BURLINGTON (CA); Michael William Arthur LEYLAND, BURLINGTON (CA); David Michael KLUMB, MENOMONEE FALLS, WI (US)

(73) Assignee: FLOW-RITE SAFETY SOLUTIONS INC., BURLINGTON (CA)

(21) Appl. No.: 13/773,458

(22) Filed: Feb. 21, 2013

Related U.S. Application Data
(60) Provisional application No. 61/601,235, filed on Feb. 21, 2012.

(51) Int. Cl. B60Q 1/00

(52) U.S. Cl. CPC B60Q 1/00
USPC 340/435

(57) ABSTRACT

A warning device includes a housing, a power source, a control unit, sensors and alarms. The control unit is in the housing. The sensors are operably connected to the control unit. The sensors detect the presence of an object in each of at least two designated detection zones. The alarms are operably connected to the control unit. The alarms are responsive to a signal from the control unit when objects have been detected in at least two designated detection zones. A method of warning of potential collisions including the steps of: defining at least two designated detection zones; detecting the presence of an object in the zones; determining when objects are present in more than one zone and determining if these are in defined potential collision combinations; and if the objects are present in the more than one zones and in the defined potential collision combinations then activating a warning.

### CROSS REFERENCE TO RELATED PATENT APPLICATION

This patent application relates to U.S. Provisional Patent Application Ser. No. 61/601,235 filed on Feb. 21, 2012 entitled FORKLIFT ACCIDENT AVOIDANCE SYSTEM which is incorporated herein by reference in its entirety.

### FIELD OF THE DISCLOSURE

This disclosure relates to vehicle safety systems and in particular to warning devices and collision avoidance systems for use with manned vehicles for example forklift and other material handling vehicles.

### BACKGROUND

With their ability to move heavy pallets and other materials, forklifts, lift trucks or materials handling equipment, (henceforth forklift(s)) have become an indispensable tool in business and industry from factories to warehouses, to construction sites and supermarkets. Forklifts play an essential part in worldwide logistics.

Unfortunately, forklifts also create an unsafe environment as collisions involving forklifts and people remain a far too frequent occurrence in the workplace. Forklift-related accidents in warehouses kill close to 100 workers each year in the United States, and result in serious injury in over 20,000 additional situations. Accidents involving forklifts and pedestrians are among the most frequently reported incidents and often involve serious or fatal injuries.

According to the National Institute for Occupational Safety & Health (NIOSH), 44% of forklift accidents involve pedestrians, and have a 58% fatality rate. National fatality data from NIOSH indicates that the three most common forklift-related fatalities involve forklift overturns, workers on foot being struck by forklifts and workers falling from forklifts. About one in every five fatalities involves another worker being struck by a forklift.

Accident reports indicate that approximately as many of these accidents occurred while the forklift was traveling forward (including tail-swing accidents) as in reverse. Most reverse travel accidents occurred within the first 10 ft. of travel, whereas most of the forward travel accidents occurred after the first 25 ft. Many of the accidents involved injury to pedestrians who were not only aware of the presence of the forklift but were working with the forklift load.

Factors that may contribute to these accidents include but are not limited to:
Ambient noise levels.
Ambient light levels.
Number of forklifts and pedestrians present, i.e. overall traffic volume in an area.
Level of training of forklift operators.
Level of education of pedestrians concerning forklift operating characteristics and how to work around them.
Physical workplace layout, including separate travel zones for pedestrians and forklifts blind zones.
Presence of audible or visible warning devices on forklift and other mobile equipment in the workplace.
Presence of audible or visible warning devices on cranes, conveyors or other stationary industrial equipment.
Lack of specific operating rules for forklift travel, such as sounding the steering wheel horn at intersections or when changing direction and coming to a stop at intersections.
Lack of enforcement by management of safe work procedures for lift truck operators and pedestrians.

Unlike automobile and pedestrian traffic, there are no universal “rules of the road” governing forklift/pedestrian interaction. Many of the largest and most sophisticated forklift users have concluded that the most effective way to reduce these accidents is to separate forklift and pedestrian traffic to the greatest extent possible, using separate travel lanes dedicated to trucks and to pedestrian traffic. Travel lanes may be marked with paint on the floor, or separated by physical barriers. Limitations may also be placed on travel areas for forklifts to keep them away from high-density pedestrian traffic, such as near washrooms, break rooms, or time clocks.

Various strategies have been developed to reduce the risk of collision between forklifts or between forklifts and pedestrians. The most common approaches to intersection or blind corner safety include the use of mirrors and institution of the practice of speed reduction or stopping in conjunction with honking of horns. Today, if feasible in the design of new facilities separate doors for personnel and material handling equipment and designated pedestrian lanes are being built to reduce the risk of collision.

Another attempt to reduce the risk of forklift incidents requires a safe work environment, a safe forklift, comprehensive worker training, safe work practices, and systematic traffic management. NIOSH recommends that employers and workers comply with OSHA (Occupational Safety and Health Administration) regulations and consensus standards, maintain equipment, and take actions to prevent injury when operating or working near forklifts.

Certain forklift manufacturers make available as optional equipment a range of different audible and visible warning devices which companies may select for their forklift. OSHA regulations and ASME B56.1 safety standards for forklifts do not require the presence of warning devices on a vehicle other than the steering wheel horn, which is standard equipment.

One study of optional warning devices indicates that approximately 70% of current forklift users equip their trucks with some form of audible or visible warning device. However, the available accident data does not show that vehicles equipped with optional warning devices are involved in a lower incidence of vehicle/pedestrian accidents than those without them. Many of the largest and most sophisticated users choose not to equip their vehicles with such devices.

Generally manufacturers of audible or visible warning devices do not provide data concerning the effectiveness of their devices. The instructions accompanying such devices merely instruct the forklift operator to always look in the direction of travel, regardless of the presence of the device.

Other products have been developed that are placed on the forklifts to sense the presence of another forklift. Sensors can also trigger an audible and visual alarm in an intersection that a forklift is entering the area.

Other products that have been developed incorporate a single sensing system that turns on a light when an object (person or machine) enters an area that is being monitored. Sensors activate warning lights to warn approaching traffic that there is a moving object in the detection area.

These systems however are susceptible to “warning fatigue” as they enter alert mode on detection of any movement, even a single object, in the detection area. The result is a de-sensitization of people and thus the tendency to ignore the alarm.

Even with the efforts of forklift manufacturers, other safety product manufacturer and OSHA—have driven a much higher level of collision awareness. Yet an unacceptable number of accidents and fatalities still occur each year.

### SUMMARY

A warning device includes a housing, a power source, a control unit, sensors and alarms. The control unit is in the housing. The sensors are operably connected to the control unit. The sensors detect the presence of an object in each of at least two designated detection zones. The alarms are operably connected to the control unit. The alarms are responsive to a signal from the control unit when objects have been detected in at least two designated detection zones.

The sensors may detect three or four designated detection zones.

The designated detection zones detected by a motion sensor may extend at least 12 feet wide, at least 8 feet high and between 6 feet and 26 feet from the motion sensor.

The sensors may be motion sensors. The sensors may be connected to the housing. The sensors may include motion sensors connected to the housing and remote sensors. The remote sensors may include one of remote motion sensors, pressure pad sensors and laser trip beam detectors.

The alarms may include at least one of high intensity LED lights, LED strip lights and audible alarms.

The power source may be a solar panel. The power source may further includes an AC/DC converter power source. The power source may include a power circuit board including at least one super capacitors.

Cables may be connected to the housing for hanging the device. A rack bracket is adapted to be attached to a rack and the alarm device may be hung from the rack bracket.

A method of warning of potential collisions in a defined space comprising the steps of: defining at least two designated detection zones; detecting the presence of an object in the designated detection zones; determining when objects are present in more than one designated detection zone and determining if these are in defined potential collision combinations; and if the objects are present in the more than one designated zones and in the defined potential collision combinations then activating a warning.

The warning may be activating lights. The lights may include one of LED strip lights, LED high intensity light and a combination thereof. The strip lights may be directed at each of the designated detection zones and the strip lights are activated concurrently responsive to activating the warning. The high intensity lights may be directed at each of the designated detection zones and are activated responsive to an object in the respective designated detection zone and responsive to activating the warning.

The warning may include an audible alarm and the audible alarm is activated responsive to activating the warning.

The designated detection zone may be defined by a motion sensor. The designated detection zone the designated detection zones detected by a motion sensor extend at least 12 feet wide, at least 8 feet high and between 6 feet and 26 feet from the motion sensor. The designated detection zone may be defined by a pressure sensitive pad. The designated detection zone may be defined by a laser light beam.

Each designated detection zone may define a path and the defined potential collision may be when objects are detected in at least two zones where the respective paths intersect.

Further features will be described or will become apparent in the course of the following detailed description.

### BRIEF DESCRIPTION OF THE DRAWINGS

The embodiments will now be described by way of example only, with reference to the accompanying drawings, in which:

FIG. 1 is a schematic view of the warning device;

FIG. 2 is a blown apart schematic view of the warning device showing the power circuit board and the control circuit board;

FIG. 3 is a schematic view of the warning device similar to that shown in FIG. 1 and showing an AC/DC adaptor;

FIG. 4 is a schematic view of the warning device similar to that shown in FIG. 1 and showing a remote sensor;

FIG. 5 is a schematic view of the warning device similar to that shown in FIG. 1 and showing a rack mounting bracket;

FIG. 6 is a top view of schematic view of a collision avoidance system using a warning device including a remote pressure pad;

FIG. 7 is a top view of schematic view of a collision avoidance system using a warning device including a laser trip beam detector;

FIGS. 8 (a) and (b) are schematic side view and top view, respectively, of a designated detection zone;

FIGS. 9 (a) and (b) are schematic side view and top view, respectively, a designated detection zone and showing a forklift truck carrying cardboard boxes at one end of the zone;

FIGS. 10 (a) and (b) are schematic side view and top view, respectively, of a designated detection zone similar to that shown in FIG. 9 but showing the forklift truck carrying cardboard boxes at the other end of the zone;

FIGS. 11 (a) and (b) are schematic side view and top view, respectively, of a designated detection zone and showing a person at one end of the zone;

FIGS. 12 (a) and (b) are schematic side view and top view, respectively, of a designated detection zone as shown in FIG. 11 but showing a person at the other end of the zone;

FIGS. 13 (a) and (b) are schematic side view and top view, respectively, of a designated detection zone and showing a person carrying a box at one end of the zone;

FIGS. 14 (a) and (b) are schematic side view and top view, respectively, of a designated detection zone showing a person at one end of the zone and a crouching person at the other end of the zone;

FIGS. 15 (a) and (b) are schematic side view and top view, respectively, of a the exhibited characteristics of a sensor; and

FIG. 16 (a) to (e) are top views of the collision avoidance system showing different configuration.

### DETAILED DESCRIPTION

The embodiments shown herein are to a system that is designed to act as a collision avoidance system and to augment forklift safety best practices. By way of example, the system is designed for use in warehouses, manufacturing facilities and other facilities in which the potential for collisions between forklift/materials handling vehicles or between people and forklift/materials handling vehicles is present. The system provides an “intelligent alert” aimed at reducing the occurrence of “warning fatigue” by generating alerts when a genuine opportunity for collision is detected.

The common theme of many collision awareness products is that they generate an alert (audible and/or visible) each time a single forklift/materials handling vehicle or person enters designated areas. In a very short period of time, in most working environments, if alarms are continuously being activated a “sensed-down” awareness occurs. The consequence of this is that when a genuine opportunity for collision sets off the alarm as a result of two parties entering blind designated areas both parties assume they alone are responsible for triggering the alert. As a consequence, each party continues as if they are the only party, leading to potential accidents.

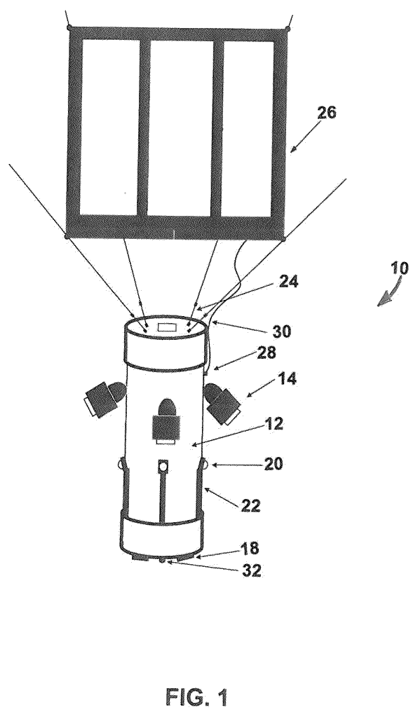

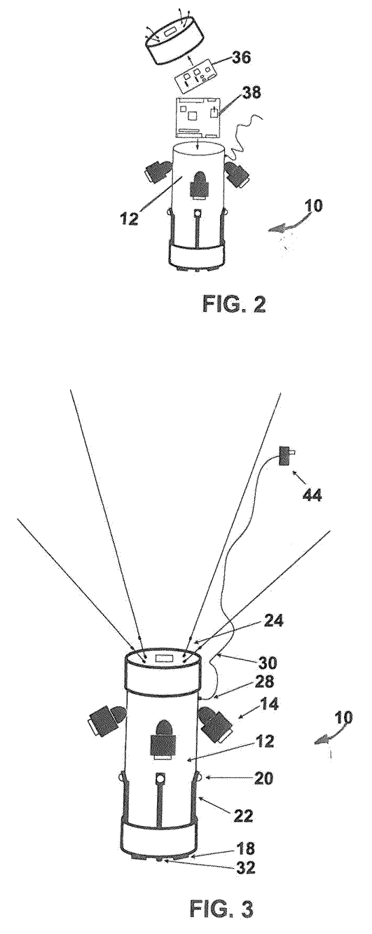

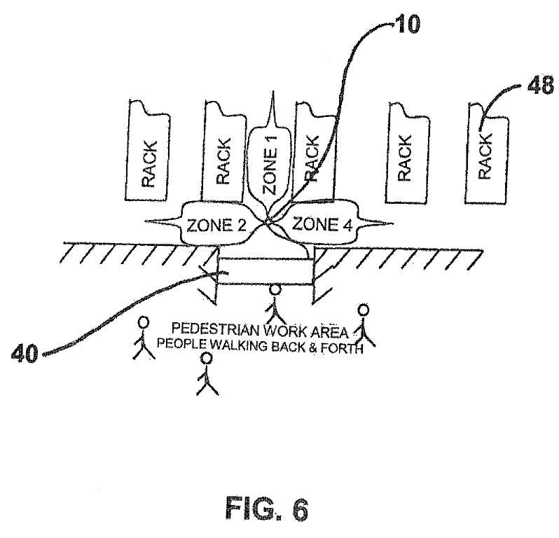

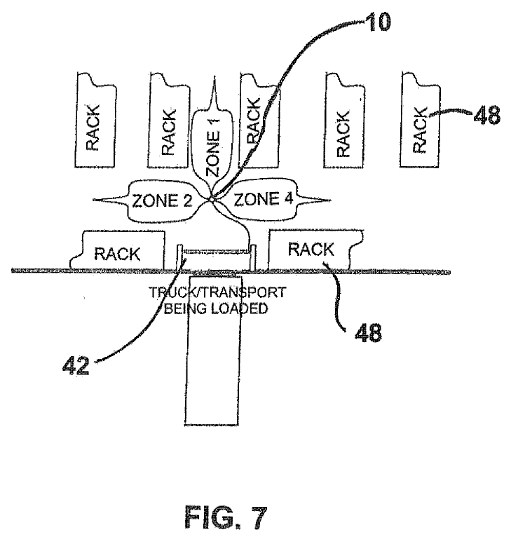

Referring to FIGS. 1 and 2, a vehicle detection and warning device is shown generally at 10. Warning device 10 includes a housing 12, a plurality of sensors 14, a plurality of alarm lights, and at least one audible alarm 18. The alarm lights may be LED (light emitting diode) high intensity alarm lights 20 and/or LED strip alarm lights 22. Warning device 10 may be suspended from cables 24. Warning device 10 may be attached to solar panel 26. Alternatively or in addition, device 10 may include a power input jack 28 and a power supply wire 30. Warning device 10 may also include a trouble light 32. Warning device 10 includes a power circuit board 36 and a power supply. Optionally, device 10 may include a remote sensor unit 34, a pressure sensitive pad 40 or a laser trip beam detector 42 (as shown in FIGS. 6 and 7 respectively). In the embodiment shown herein there are four sensors 14, four high intensity lights 20 and four strip lights 22 equally spaced around the housing 12. However, it will be appreciated by those skilled in the art that the number of sensors, lights and alarms may vary depending on the specific configuration of the space that is being monitored.

The housing 12 may be a high impact PVC enclosure that houses control circuit board 38 and power circuit board 36. The warning devices, namely the LED high intensity lights 20, the LED strip lights 22a and the audible alarm 18 are mounted on the housing 12. As well the sensors 14 are mounted on the housing 12. The warning device 10 may be suspended from the ceiling or other overhead beam or other bracket with cables 24 that are connected to the housing 12.

The control circuit board 38 is a printed circuit board populated by the electronic components through which the functions of the warning device 10 are implemented and controlled. By way of example, the control circuit board 38 electronic components include a programmable microprocessor; F-RAM memory; a Zigbee compliant data communications integrated circuit; and the circuitry to support a range of “presence” detection technology, both analog and digital, and visual and audible warning devices. Preferably, all of the components are designed to operate on very low power and are Reduction Of Hazardous Substances (RoHS) compliant.

A plurality of sensors are operably connected to the warning device 10. By way of the example, the plurality of sensors may include motion sensor 14 attached to the housing 12, remote sensors 34, pressure sensitive pads 40 and/or laser trip beam detector 42. The sensors may be mounted directly on the control housing 12 or distributed remotely 34. The sensors may be connected by wire or through remote data communications. The warning device 10 monitors a plurality of designated detection zones using a combination of the sensors. The sensors and the alarms are operably connected to the control circuit board 38 such that the alarms are responsive to the detection of something in two or more designated detection zones. The responsiveness of the alarms is programmable. The warning device 10 is programmed to require at least two detection devices be activated within a predetermined time before an alarm is triggered.

One example of a power supply includes a power circuit board 36 which is a printed circuit board populated by the electronic components required to power the embodiments. By way of example, the significant electronic components includes at least one super capacitors; comparator IC's; operational amplifiers and various inductors and transistors. Preferably all components are, where possible, RoHS compliant and low power.

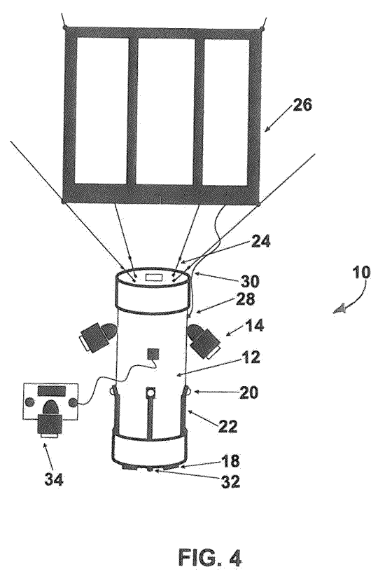

The power circuit board 36 of the warning device 10 may have two alternate electrical power sources. The power source may be either a solar panel 26 (shown in FIGS. 1 and 4) or an AC/DC power converter 44 (shown in FIG. 3) or both. Preferably, the solar panel option utilizes a solar panel 26 designed to use typical indoor incandescent, florescent, LED or other common indoor light sources to generate the energy required to operate the embodiments. The power circuit board 36 is tuned to accommodate power from either the solar panel 26 or the supplied AC/DC converter 44. The solar panel is designed to be mounted on the suspension cables 24 or it may be mounted remotely on its own suspension cables. In both cases the solar panel is connected by wire 30 through the control housing power input jack 28 to the power circuit board 36. The closer the solar panel is to the light source the greater the solar panel efficiency. The ability to remotely locate the solar panel offers an added degree of flexibility especially in some newer “Near Lights Out” warehouses. A “farm” of a plurality of solar panels may be created around a small set of lights that are always left on.

The AC/DC converter option uses a supplied AC/DC power converter 44 that converts standard AC power (120 volt or 220 volt) into low voltage DC power. Preferably the converter is an efficiency level v LPS switching power supply. The converter also supports a range of international wall plugs.

The motion detection sensors 14 and the remote sensor 34 may be infrared, ultrasound or other sensor technology capable of generating an analog or digital signal which may be interpreted by the microprocessor as indicating the presence of a person or vehicle in a designated detection zone. The choice of the sensor implemented is dictated by the characteristics of the detection zone to be monitored. The primary characteristics being type of traffic, distance, width, height and temperature. Preferably the sensors are very low power sensors.

Preferably the alarm components include both visible and audible alarms. The visible alarms may include low power super bright LEDs lights 20 optionally amber or blue in colour to meet varying corporate safety standards. Low power consumption with maximum luminosity is a preferred design option. Preferably, there are two types of LED lights incorporated in the embodiments. The first is LED multi-bulb strip lights 22 that are mounted vertically under each sensor. The second type is single bulb high intensity LED 20 mounted to allow focus of the beam into the detection zone. Both types of lights are intended to attract maximum attention. Upon activation, the LED's turn-on and flash as per programmed parameters. For example, a basic four motion sensor warning device default program is to turn-on and flash all four LED strip lights 22 for a duration of eight seconds. In addition the high intensity LED 20 that is aimed into the detection zones that triggered the alarm is also activated. The flash rate and duration are programmable for both visual alarms. Note that the user may change the flash rate and duration are changeable depending on the user's needs.

Preferably, the audible alarm 18 consists of two piezo buzzers. Each buzzer operates at a fixed high intensity frequency at the maximum recommended worker safe decibel volume. The two frequencies have been chosen in the spectrum of sound to minimize the chance of the alarm not being heard in a typical working environment. The audible alarm may be disabled if desired. The beep rate and duration of audible alarm are programmable. The audible alarm is typically set to correspond to the LED light flash rate, however, this may be changed depending on the user's needs.

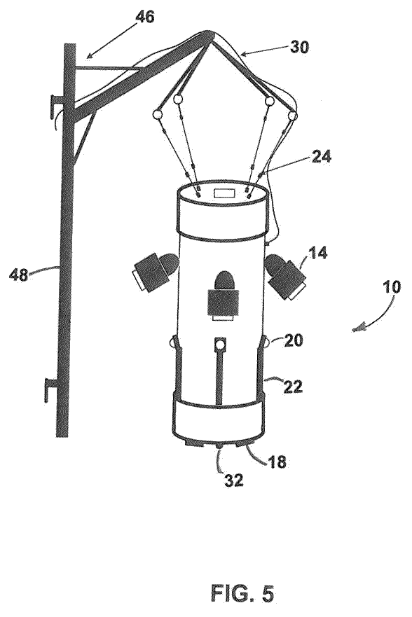

In one embodiment, the warning device 10 is equipped with a standard set of four short suspension cables 24 attached to the top of the control housing 12. The four points of suspension aid in maintaining stability and reducing movement when the device is mounted. The short suspension cables may be attached to variable length suspension cables that are suspended from rafters or ceiling hooks. In one embodiment the warning device 10 is designed to be located sixteen feet above the intersection of the detection zones. The warning device 10 has an optional rack mounting bracket 46 which attaches to standard warehouse racking 48 as shown in FIG. 5. The suspension cables may be used to mount the solar panel 26. The solar panel may be connected to the cables at the most effective height to optimize access to light or operational clearance.

The warning device 10 is equipped with a trouble indicator light 32. The microprocessor of the control circuit board is programmed to detect component and power failure. If a problem is detected the red trouble indicator light 32 on the base of the embodiments is turned on.

As stated above, the warning device 10 is for use at locations that utilize materials handling vehicles (forklifts) in their facilities. As such warning device 10 is designed to detect the presence of vehicles in designated detection zones.

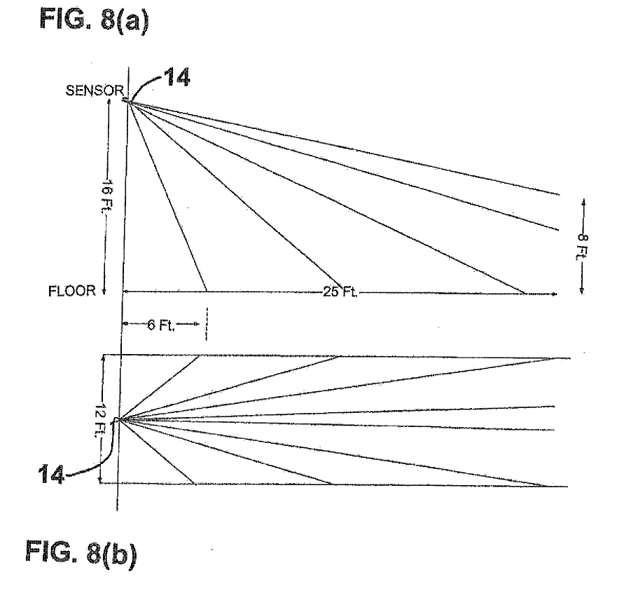

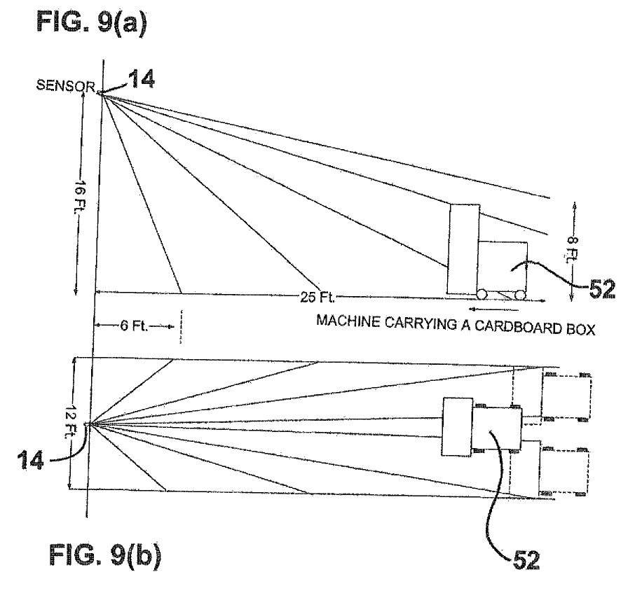

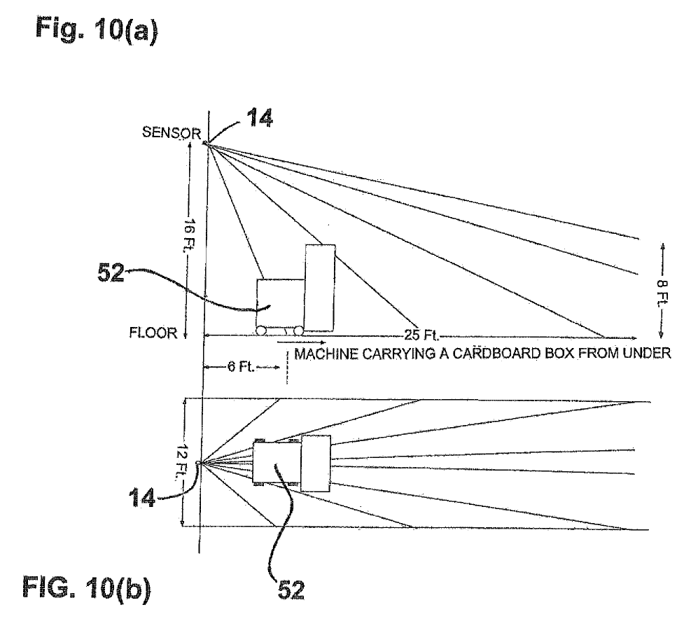

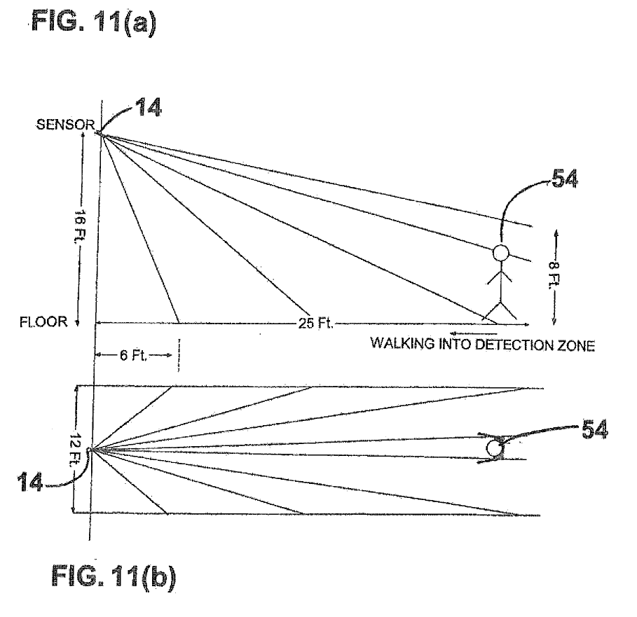

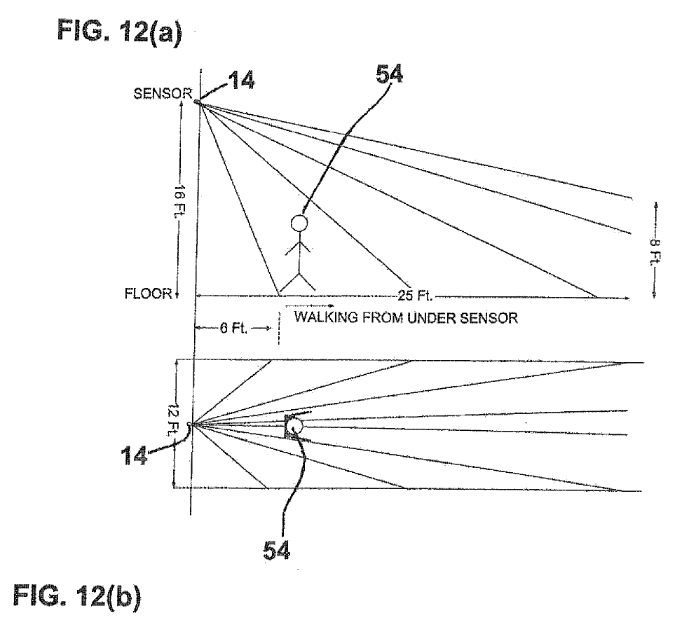

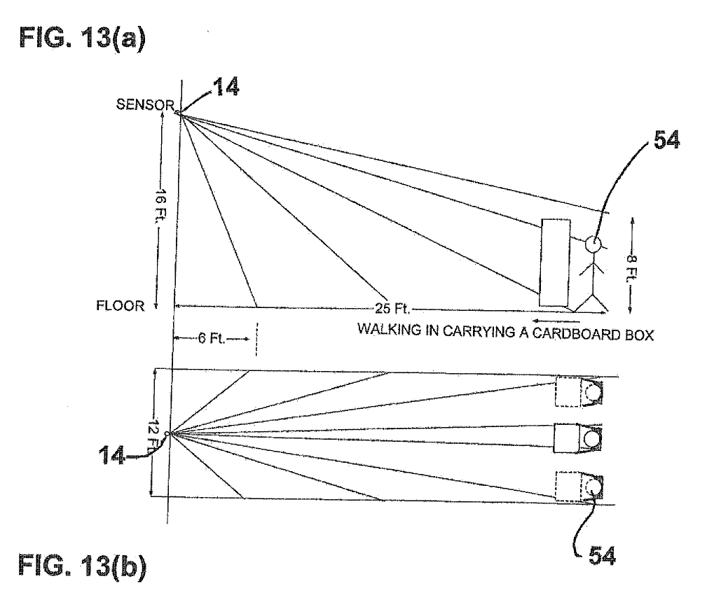

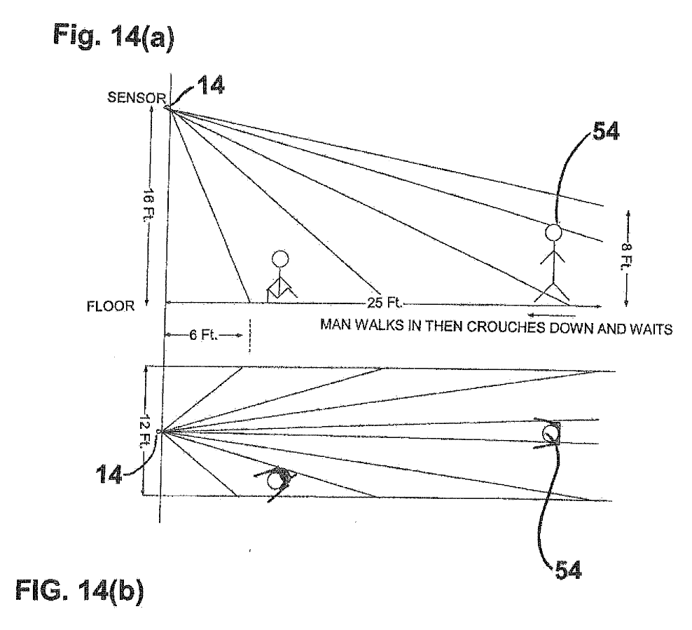

Referring to FIGS. 8 to 15, in order to define a designated detection zone a number of parameters were considered. Best safety practice travel speed of a forklift is 3 MPH. However, there is evidence that this speed is regularly exceeded. It is believed that the average unloaded speed is closer to 8 MPH. These speeds translate into speeds of 4.4 feet/second and 14.7 feet/second respectively. The alarm recognition/braking process takes about 3 seconds at the lower speed. Depending upon floor surface conditions, it takes about 6 seconds at the higher speed. At an intersection, best safety practice is to come to a stop before proceeding through the intersection. Even high speed operators usually slow down to at least to the 3 MPH. Using this assumption, the device was designed based on an average speed of 5 MPH or 7.3 feet/second. Using this number and an alarm recognition/braking time of 3.5 seconds, at a detection range of 25 feet was selected. This range was selected as the distance from the intersection that detection should first occur. The standard aisle width in a conventional warehouse facility is 12 feet and this is used as the preferred width of the detection zone 50. Assuming this aisle width and that the warning device 10 is placed at the centre of an intersection of two aisles, there is a zone of 6 feet out from the device that is fully visible in all directions that does not require monitoring. Accordingly a motion sensor designated detection zones may extend at least 12 feet wide, at least 8 feet high and between 6 feet and 25 feet from the motion sensor. The collision avoidance system is intended to heighten the awareness of potential collision situations between forklifts 52 and between forklifts 52 and pedestrians 54. Forklifts have a mass that is distributed close to the ground.

In view of this fact and the need to also detect the presence of people, 8 feet may be used as the height of the detection zone”.

To achieve this target detection zone and to ensure safe forklift clearance, it was determined, through experimentation with various test motion detectors, that the mounting height of the motion detector would be 16 feet.

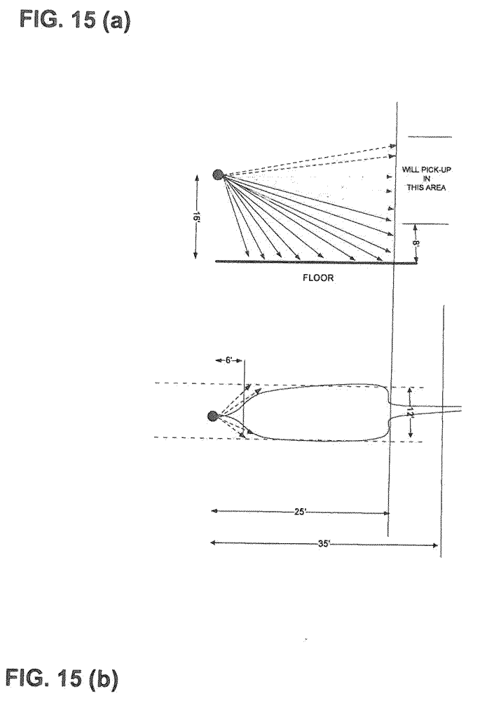

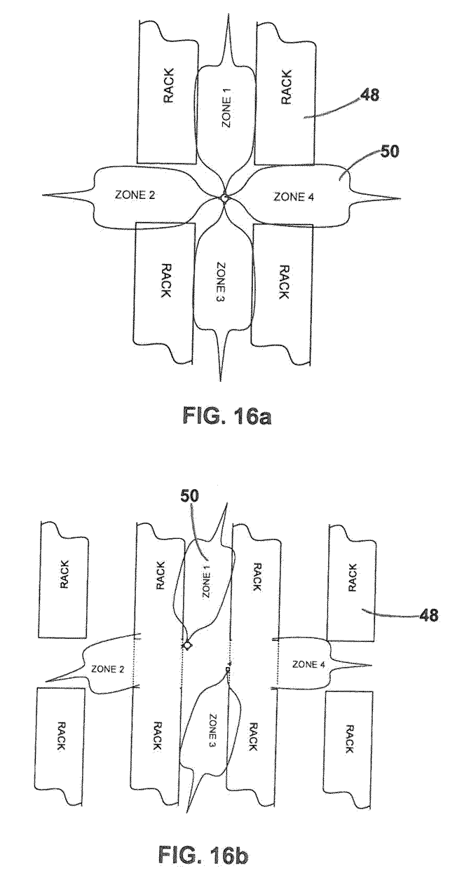

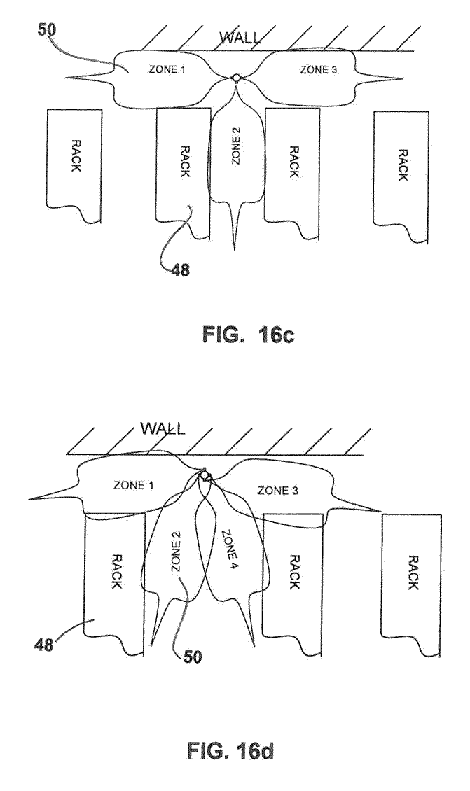

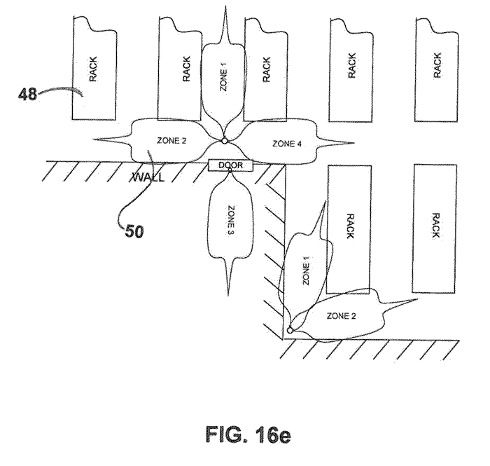

As a result of the calculations and the above tests, sensors were selected that would exhibit the characteristics required. FIG. 15 shows a profile of a preferred sensor for a detection zone. This detection zone pattern is used in the different configurations shown in FIG. 16(a) through (e).

The collision avoidance system is designed to detect genuine potential collision situations that occur when forklifts and/or people approach an area where they cannot readily identify the presence of the other party. If those parties were to continue into that area unaware of the other party, there is the potential that a collision between the parties would occur. The collision avoidance system uses a plurality of motion or presence sensors to monitor a plurality of detection zones where forklifts and/or people and forklifts converge and the potential for collision exists. The sensors are typically attached to one or more warning devices.

In use, the first step in configuring a collision avoidance system is to identify designated detection zones 50. These are the aisles or areas of the facility where potential exists for a pedestrian or forklift to blindly emerge or enter and collide with another unsuspecting party. An array of sensor of different types may be utilized by the warning device to monitor these detection zones. Even though the warning device has the capability to support such presence detection sensors as weight/pressure pads and laser arrays for example, the collision avoidance system will be described using motion detectors 14 with the characteristics of the detection zone pattern 50 described above.

Referring to FIG. 16 (a) through (f) a number of configurations are shown and described to illustrate the process of the collision avoidance system.

The sensors 14 and 34 monitor the designated detection areas on a fixed sampling cycle. Detection of motion in the sensor's designated detection zone 50 results in a trigger signal being raised. The microprocessor attached to the control circuit board 38 monitors the sensors for these signals. Upon detection of a signal, the microprocessor writes an entry in the control board F-RAM. This entry contains a time stamp (date and time) and the signal source. Only if the microprocessor detects signals from two or more sensors in a monitoring cycle is logic applied to determine if the signals are from sensors defined as monitoring potential collision zones.

FIG. 16 depicts several implementation scenarios indicating the warning device and other remote sensor placement and identifying the designated detection zones.

FIG. 16a depicts the most common aisle implementation that defines four designated detection zones. Placement is at the centre of the intersection created by two rows of racking. This configuration would have four sensors 14 mounted on the control housing 12. An alarm is raised only when presence is detected in one of the following combinations: Zone 1 and Zone 2; or Zone 1 and Zone 4; or Zone 3 and Zone 2; or Zone 3 and Zone 4. Each zone defines a path and when the paths defined by the zones have objects therein and the paths intersect then an alarm is activated.

FIG. 16b depicts a variation on the previous implementation. In this implementation, two of the aisles between racks 48 are bridged and product stored on racking above the aisles. The warning device 10 cannot be suspended over the intersection because it would interfere with access to product stored on the bridge. In this implementation the rack mounting bracket 46 would be employed. The warning device would be configured with two sensors 14 mounted on the control housing 12 and two remote sensors 34. This configuration is used to avoid detections that would result in unnecessary alarms in keeping with the objective of raising only genuine alarms. An alarm is raised only when presence is detected in one of the following configurations Zone 1 and Zone 2; or Zone 1 and Zone 4; or Zone 3 and Zone 2; or Zone 3 and Zone 4.

FIG. 16c depicts an implementation at the end of an aisle. Placement is at the centre of the intersection created by two rows of racking and an end wall. This configuration would have three sensors 14 mounted on the control housing 12. An alarm is raised only when presence is detected in one of the following configurations Zone 1 and Zone 2; or Zone 3 and Zone 2.

FIG. 16d is a variation on the previous implementation. The diagram depicts an implementation at the end of an aisle or staging area. The difference in this implementation is that the aisle or staging area is double the width of a normal aisle. The warning device would be configured with four sensors 14 mounted on the control housing 12. This implementation takes advantage of the control housing sensor mounting arrangement and sensor housing cup design. The two sets of opposing sensors (sensors 1 & 3 and sensors 2 & 4) are mounted at different heights on the control housing allowing the sensors to be aimed in opposite directions without interfering with each other. An alarm is raised only when presence is detected in one of the following configurations Zone 1 and Zone 2; or Zone 1 and Zone 4; or Zone 2 and Zone 3; or Zone 3 and Zone 4.

FIG. 16e depicts two implementations. The first is a four detection zone implementation. It employs three control housing sensors 14 similar to FIG. 16c and one remote sensor 34. The remote sensor is located on the other side of a door. Extending the designated detection zones remotely allow the warning device to provide warning on both sides of high speed doors or in pedestrian entry situations. An alarm is raised only when presence is detected in one of the following configurations Zone 1 and Zone 2; or Zone 1 and Zone 4; or Zone 3 and Zone 2; or Zone 3 and Zone 4. The second implementation depicted in this diagram is a simple two detection zone scenario in a blind corner. The control housing 12 is either suspended or the mounting bracket used in the corner. Two mounted sensors 14 are employed to monitor two detection zones. An alarm is raised only when presence is detected in one of the following configurations Zone 1 and Zone 2.

If the microprocessor logic determines that the signals are from defined potential collision zones, the microprocessor signals the LED strip lights 22 and the four sets of lights commence flashing. The microprocessor also signals the audible alarm 18 (if the audible alarm has not been marked as optionally disabled) and the audible alarm commences beeping. The two LED high intensity lights 20 associated with the triggering detection zones are signaled and commence flashing. The microprocessor also indicates in the entry it writes to the control board F-RAM memory that an alarm has been triggered. The alarms flash for the predefined time. When the predefined time passes, the microprocessor resets and re-commences monitoring for signals from the sensors.

As discussed above, the warning device 10 may be powered by a solar panel 26 or by a low voltage AC/DC converter. Preferably the warning device is powered by the solar panel 26 and the components of device 10 are tailored to the requirements imposed by the use of solar energy.

The solar panels 26 used are specifically designed to operate using indoor lighting (incandescent, florescent, zenon, LED etc. lighting). Power is only generated when the panel is exposed to light. Even though indoor lighting is less susceptible to dark times than sunshine the principals of operation still apply. To avoid power interruption in dark periods the solar energy generated in light times is stored in an intermediary vehicle. This intermediary power storage vehicle then discharges providing a consistent uninterrupted power supply to operate the device. The intermediary power storage vehicle is one or more super capacitor.

In a solar environment where the objective is to harvest as much energy as possible when light is available, batteries are constantly being re-charged unless circuitry is introduced to stop charging until a certain discharge has occurred. Stopping charging wastes the opportunity to harvest energy.

Super capacitors are used as an intermediary power storage vehicle. This emerging technology has the benefit of being totally “Green”, may be re-charged millions of times, have an extremely low failure rate and they are small/compact and relatively inexpensive relative to batteries. The warning devices power circuit board 36 is populated with the circuitry to convert either the solar energy 26 or the AC/DC converter 44 power to charge the two super capacitors on the board. The circuitry then transforms the power from the super capacitors to supply the voltages and current need to power the control circuit board 38.

The super capacitor power supply has the advantage of being able to power the control circuit board for one or more days in the absence of external power. The duration is dictated by the alarm activity required. This ability coupled with the very high reliability also ensures the control unit has the power shut down gracefully and continue to power the trouble light indicator and power the Zigbee IC (integrated circuit), assuming it is not the failing component, and to transmit an alert.

The microprocessor writes an entry into F-RAM memory whenever presence is detected by a sensor. On a preset schedule the microprocessor wakes up the Zigbee compliant data communications IC on the control board 38. The Zigbee IC then transmits the content of the F-RAM over a Zigbee network to a Personal Computer equipped with a Zigbee compliant receiver. The data transmitted can then be analyzed and used for reporting incident occurrences and traffic patterns in the facility.

The Zigbee IC is also used to transmit component failure alerts detected by the microprocessor. The Zigbee IC is also capable of receiving data. It is used to change parameters of operation such as deactivating/activating the audible alarm 18, setting the number of alarm flashes/beeps and receiving new versions of the microprocessor software.

The Zigbee IC is also used for testing the unit at installation time. The Zigbee IC selected is very low power. When not in use it sleeps consuming even less power.

The warning device 10 may be powered by solar technology—reducing the ongoing operational and maintenance costs. It reduces installation costs associated with A/C hard-wiring. 2. The warning device 10 can also be power by low voltage DC power from a provided high efficiency AC/DC converter. This also simplifies installation and enhances the flexibility if to be moved within the facility or to another facility.

The collision avoidance system 10 monitors high potential collision areas and utilizes a variety of sensor types which are adjustable and which communicate with a micro-processor when a motion is detected. The warning device's 10 micro-processor will not trigger an alert until two motions are detected in a designated area and then alarms will communicate (audible and/or visual) the potential of a collision.

The collision avoidance system 10 can address a situation where a human being may stop moving only slightly and thus sense a potentially safe environment. To address this, the warning device's sensors (infrared and/or ultrasound) can detect the presence of a human being even when motion is minimal.

The collision avoidance system 10 can detect the potential of collision in work areas where forklifts enter the area to drop off or pick up products. In many cases the backing up and turning of the forklift has led to crushing type fatalities and injuries.

The warning device 10 has the ability to auto-reset after an adjustable predetermined interval. This addresses any potential of people or forklifts turning around in and out of the sensor's area. The warning device can store data including date-stamped counts of sensor activation for use in analyzing traffic patterns that may be used to identify potentially hazardous locations.

The collision avoidance system 10 can also optionally include data communications capability that may be used in conjunction with existing computer technology to alert management (determined by the customer) as to when a detection or alarm occurred. A message may be sent notifying the customer of time and location of an occurrence. This could enable the end-user to investigate the occurrence and/or instigate additional training.

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. In one non-limiting example, the terms “about” and “approximately” mean plus or minus 10 percent or less.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

Note, nothing in this specification should be construed as a promise of this invention.

What is claimed is:

1. A warning device comprising:
a housing;
a power source;
a control unit in the housing;
sensors operably connected to the control unit, the sensors detecting the presence of an object in each of at least two designated detection zones; and
alarms operably connected to the control unit, the alarms are responsive to a signal from the control unit when objects have been detected in at least two designated detection zones.

2. The warning device of claim 1 wherein the sensors detect four designated detection zones.

3. The warning device of claim 1 wherein the sensors detect three designated detection zones.

4. The warning device of claim 2 wherein the designated detection zones detected by a motion sensor extend at least 12 feet wide, at least 8 feet high and between 6 feet and 26 feet from the motion sensor.

5. The warning device of claim 1 wherein the sensors are motion sensors.

6. The warning device of claim 1 wherein the sensors are connected to the housing.

7. The warning device of claim 1 wherein the sensors include motion sensors connected to the housing and remote sensors.

8. The warning device of claim 7 wherein the remote sensors include one of remote motion sensors, pressure pad sensors and laser trip beam detectors.

9. The warning device of claim 1 the alarms include at least one of high intensity LED lights, LED strip lights and audible alarms.

10. The warning device of claim 1 wherein the power source is a solar panel.

11. The warning device of claim 10 wherein the power source further includes an AC/DC converter power source.

12. The warning device of claim 1 wherein the power source includes a power circuit board including at least one super capacitors.

13. The warning device of claim 1 further including cables connected to the housing for hanging the device.

14. The warning device of claim 13 further including a rack bracket adapted to be attached to a rack and the alarm device is hung from the rack bracket.

15. A method of warning of potential collisions in a defined space comprising the steps of:
defining at least two designated detection zones;
detecting the presence of an object in the designated detection zones;
determining when objects are present in more than one designated detection zone and determining if these are in defined potential collision combinations; and
if the objects are present in the more than one designated zones and in the defined potential collision combinations then activating a warning.

16. The method of claim 15 wherein the warning is activating lights.

17. The method of claim 16 wherein the lights include one of LED strip lights, LED high intensity light and a combination thereof.

18. The method of claim 17 wherein strip lights are directed at each of the designated detection zones and the strip lights are activated concurrently responsive to activating the warning.

19. The method of claim 18 wherein high intensity lights are directed at each of the designated detection zones and are activated responsive to an object in the respective designated detection zone and responsive to activating the warning.

20. The method of claim 19 wherein the warning further includes an audible alarm and the audible alarm is activated responsive to activating the warning.

21. The method of claim 15 wherein the designated detection zone is defined by a motion sensor.

22. The method of claim 21 wherein the designated detection zone the designated detection zones detected by a motion sensor extend at least 12 feet wide, at least 8 feet high and between 6 feet and 26 feet from the motion sensor.

23. The method of claim 15 wherein at least one of the designated detection zone is defined by a pressure sensitive pad.

24. The method of claim 15 wherein at least one of the designated detection zone is defined by a laser light beam.

25. The method of claim 15 wherein each designated detection zone defines a path and the defined potential collision is when objects are detected in at least two zones where the respective paths intersect.
